(19) United States
(12) Patent Application Publication
(10) Pub. No.: US 2026/0094748 A1
(43) Pub. Date: Apr. 2, 2026

(54) 3D-SEGMENTED MULTI-MATERIAL CORE

(71) Applicant: GM Global Technology Operations LLC, Detroit, MI (US)

(72) Inventors: Yilun Luo, Ann Arbor, MI (US); Saranraj Karuppuswami, Farmington Hills, MI (US); Minh-Khai Nguyen, Troy, MI (US); Renato Amorim Torres, Pontiac, MI (US); Song He, Troy, MI (US); Lei Hao, Troy, MI (US); Mazharul Chowdhury, Canton, MI (US)

(73) Assignee: GM Global Technology Operations LLC, Detroit, MI (US)

(21) Appl. No.: 18/899,169

(22) Filed: Sep. 27, 2024

(51) Int. Cl. H01F 3/14; B60L 50/60

(52) U.S. Cl. CPC H01F 3/14; B60L 50/60; B60L 2210/40

(57) ABSTRACT

A multi-material choke, comprising one or more sections arranged with respect to a longitudinal axis and extending between a first end and a second end, the one or more sections each defining at least one opening that extends between the first end and the second end, and the one or more sections including one or more materials arranged with respect to the longitudinal axis.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to electric vehicles and, more particularly, to a choke for an electric vehicle.

Electrical chokes (i.e., inductors) are widely used in battery chargers, inverters, DC-DC converters, electromagnetic interference (EMI) filters, and more generally, power conversion systems (PCS) of electric vehicles. Chokes can be configured to provide resistance to alternating current (AC) while allowing direct current (DC) to freely pass by. Many existing systems are single material chokes that cannot address more than one form of interference (i.e., electrical, thermal, or mechanical, etc.). Shortcomings of existing systems are addressed by one or more aspects of the present disclosure.

### SUMMARY

In one configuration, a multi-material choke is provided and includes one or more sections arranged with respect to a longitudinal axis and extending between a first end and a second end, the one or more sections each defining at least one opening that extends between the first end and the second end, and the one or more sections including one or more materials arranged with respect to the longitudinal axis.

The multi-material choke may include one or more of the following optional aspects. For example, the at least one opening of each of the one or more sections can be coaxial along the longitudinal axis.

According to at least one aspect, at least one of the one or more sections can include a base and one or more inserts disposed in the base. The one or more inserts can be spaced about the longitudinal axis. The base and the one or more inserts can define the at least one opening that extends between the first end and the second end. The base can be made of a first material and the one or more inserts can be made of one or more materials that are different than the first material.

According to another aspect, the multi-material choke can include one or more layers arranged radially inwardly with respect to the base and the one or more inserts. The base, the one or more layers, and the one or more inserts of at least one of the one or more sections are made of different materials.

According to at least one example, the one or more sections can include a majority constituent and one or more minority constituents. At least one of the majority constituent or the one or more minority constituents are made of a nanocrystalline material.

In another configuration, a multi-material choke for a vehicle is provided and includes one or more sections arranged adjacent to each other with respect to a longitudinal axis. The one or more sections each include a base, one or more inserts disposed in the base and at least one opening defined by the base and the one or more inserts.

The multi-material choke for the vehicle may include one or more of the following optional aspects. For example, the base can be made of a first material and the one or more inserts can be made of one or more materials that are different than the first material.

According to at least one aspect, the base includes a nanocystalline material and the one or more inserts include a nanocystalline material.

According to another aspect, the base can include an inner layer and an outer layer that is spaced radially from the inner layer, and the one or more inserts are intermediary layers that are arranged radially between the inner layer and the outer layer.

According to at least one example, the one or more inserts can be arranged about a perimeter of the base and can be spaced about the longitudinal axis.

According to another example, the base can include a majority constituent and the one or more inserts can include one or more minority constituents.

In another configuration, a vehicle is provided and includes a vehicle body, a propulsion system coupled to the vehicle body, including an inverter having an input and an output, a battery communicatively coupled to the input of the inverter, and a motor communicatively coupled to the output of the inverter, and a multi-material choke arranged with respect to the propulsion system. The multi-material choke including one or more sections arranged with respect to a longitudinal axis and extending between a first end and a second end, the one or more sections each defining at least one opening that extends between the first end and the second end, the one or more sections including a majority constituent and one or more minority constituents, the majority constituent being selected to target one of a mechanical, electrical, or thermal property and the one or more minority constituents being selected to target the other of a mechanical, electrical, or thermal property.

The vehicle may include one or more of the following optional aspects. For example, the multi-material choke can be arranged between the battery and the input of the inverter.

According to at least one aspect, the multi-material choke can be arranged between the output of the inverter and the motor.

According to another aspect, the multi-material choke can be arranged within the motor.

### BRIEF DESCRIPTION OF THE DRAWINGS

The drawings described herein are for illustrative purposes only of selected configurations and are not intended to limit the scope of the present disclosure.

FIG. 1 is a front perspective view of a vehicle including a propulsion system according to principles of the present disclosure;

FIG. 2A is a schematic circuit diagram of a first configuration of the propulsion system of FIG. 1 including a choke;

FIG. 2B is a schematic circuit diagram of a second configuration of the propulsion system of FIG. 1 including a choke;

FIG. 2C is a schematic circuit diagram of a third configuration of the propulsion system of FIG. 1 including a choke;

FIG. 3 is a side view of a configuration of a choke according to principles of the present disclosure;

FIG. 4 is a perspective view of another configuration of a choke according to principles of the present disclosure;

FIG. 5 is a perspective view of another configuration of a choke according to principles of the present disclosure; and

FIG. 6 is a perspective view of another configuration of a choke according to principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

In general, battery electric vehicles (BEVs), plug-in hybrid electric vehicles (PHEVs), hybrid electric vehicles (HEVs), and fuel cell electric vehicles (xEV) can be affected by electromagnetic interference (EMI). For instance, EMI can interfere with operation of vehicle electronics and/or violate regulations of EMI. EMI is a process by which electromagnetic energy is transmitted from one electric device to another via radiation and/or conducting paths. Some types of EMI include radiated EMI, common-mode EMI, and differential EMI.

Radiated EMI emission starts from an emitting source, propagates via a radiating path, until it reaches a susceptible receiver. Strength of radiated EMI may depend on the source and the device and the susceptible receiver.

Common-mode EMI can be electrically generated when a circuit with large voltage slew rate (i.e., dV/dt) has a significant parasitic capacitance to ground. In other words, common-mode EMI appears as an unwanted current measured on one or more conductors in parallel and a common reference ground.

Differential EMI can be a signal that appears on two lines of a closed loop, but current flow is in opposite directions. This generally appears in series with a desired signal.

Typically, existing chokes rely on costly materials to manage one or more types of EMI and/or to filter noise currents. According to principles of the present disclosure, a choke is provided for reducing cost, reducing weight, improving thermal conductivity, and/or improving inductance for a target frequency.

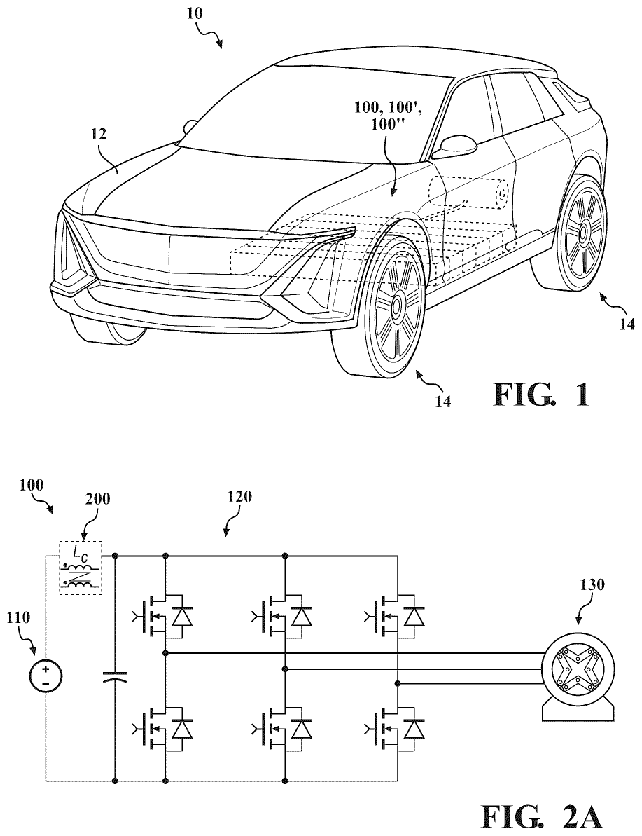

With reference to FIG. 1, an illustrative example of a vehicle 10 having a vehicle body 12 is provided. The vehicle 10 includes one or more wheels 14 coupled to the vehicle body 12. Additionally, the vehicle 10 includes a propulsion system 100 for providing power to at least one of the one or more wheels 14 to propel the vehicle 10.

In general, the propulsion system 100 includes a power source (e.g., a battery) 110, an inverter 120, and an electric motor (i.e., motor). The inverter 120 includes an input coupled to the battery 110 and an output coupled to the motor 130.

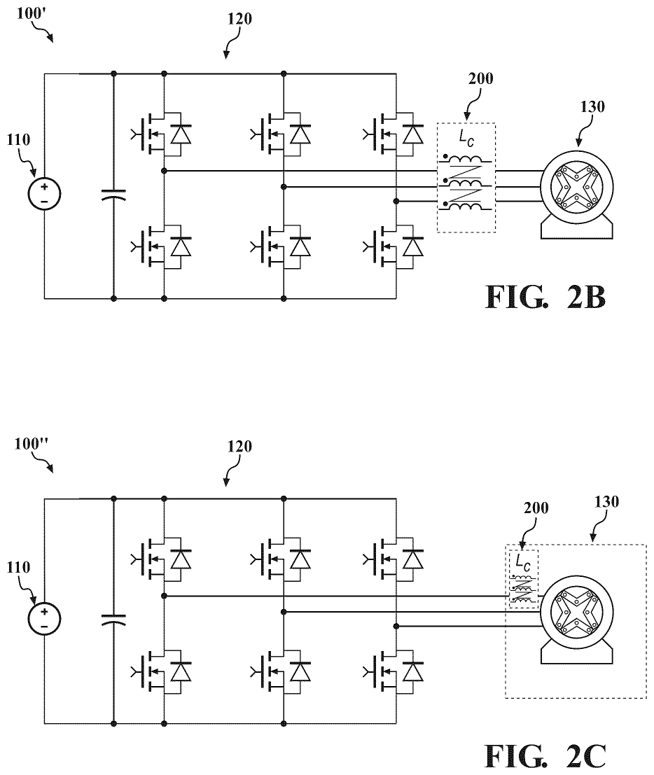

In one configuration, as shown in FIG. 2A, the propulsion system 100 also includes a choke 200 communicatively coupled to and arranged between the battery 110 and the input of the inverter 120. Arranging the choke 200 between the battery 110 and the inverter 120 may be desirable for reducing EMI emitted to or received from the other systems connected to the battery.

In another configuration, as shown in FIG. 2B, the propulsion system 100′ includes the choke 200 communicatively coupled to and arranged between the output of the inverter 120 and the motor 130. Arranging the choke 200 between the inverter 120 and the motor 130 may be desirable for reducing EMI, common mode current, and bearing current.

In yet another configuration, as shown in FIG. 2C, the propulsion system 100″ includes the choke 200 communicatively coupled to and arranged within the motor 130. Arranging the choke 200 within the motor 130 may be desirable for reducing the packaging size, overall weight, and increasing power density.

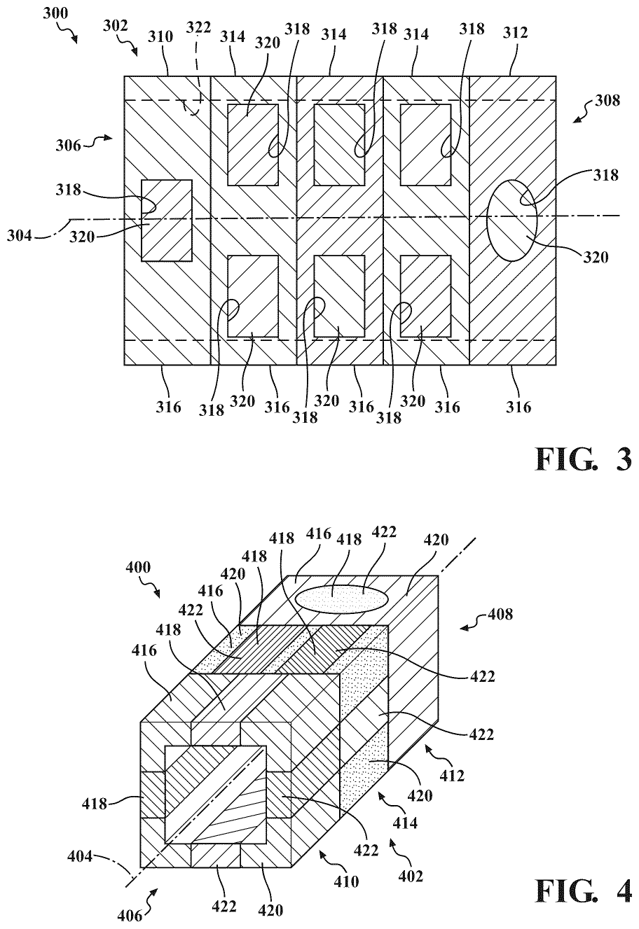

FIG. 3 illustrates an illustrative configuration of a choke 300. This configuration is similar in many respects to the configuration of FIGS. 1 and 2A-2C. Accordingly, the descriptions of the configurations are hereby incorporated into one another, and description of subject matter common to the configurations generally may not be repeated.

With reference to FIG. 3, the choke 300 is provided and includes one or more sections 302 arranged adjacent to one another with respect to a longitudinal axis 304 and made of one or more materials to enhance and/or target electrical, thermal, and/or mechanical properties. The choke 300 includes a first end 306 and a second end 308 spaced from the first end 306 with respect to a longitudinal axis 304. The one or more sections 302 can include a first end section 310, a second end section 312 spaced from the first end section 310, and one or more inner sections 314 arranged between the first end section 310 and the second end section 312. The one or more sections 302 each include a base 316 that can have one or more through holes 318 that extend through a portion of the base 316. In other words, some of the one or more sections 302 may not include any through holes. The base 316 can be partially defined by a perimeter or circumference that defines a rectangular, cylindrical, or another shape. One or more inserts 320 can be disposed in the one or more through holes 318 of the base 316. The base 316 of each of the one or more sections 302 can be made of a first material and the one or more inserts 320 can be made of one or more materials that are different than the first material. For instance, each base 316 of the one or more sections 302 and the one or more inserts 320 can be made of a variety of nanocystalline materials. According to one aspect, the base 302 of the first end section 310, the second end section 312, and the one or more inner sections 314 can each be made of one or more materials. According to one aspect, the one or more through holes 318 can be rectangular, circular, or another shape and the one or more inserts 320 can have a shape that corresponds with the one or more through holes 318. In assembly, the base 316 and the one or more inserts 320 can define an opening 322 in each of the one or more sections 302. The opening 322 can extend from the first end 306 to the second end 308 and can be configured to receive one or more wires or cables (not shown) that extend from the first end 306 to the second end 308. According to one aspect, the opening 322 of each of the one or more sections 302 are coaxial along the longitudinal axis 304.

The combination of the materials of each base 316 and the materials and the position of the one or more inserts 320 within each base 316 can vary from the present illustrative configuration to further enhance and/or target electrical, thermal, and/or mechanical properties of the choke 300. Additionally, stacking the one or more sections 302 with respect to each other and along the longitudinal axis 304 can be desirable to tailor and enhance performance of the choke 300, for example.

FIG. 4 illustrates another illustrative configuration of a choke 400. This configuration is similar in many respects to the configuration of FIGS. 1 and 2A-2C and FIG. 3. Accordingly, the descriptions of the configurations are hereby incorporated into one another, and description of subject matter common to the configurations generally may not be repeated.

With reference to FIG. 4, the choke 400 is provided and includes one or more sections 402 arranged adjacent to one another with respect to a longitudinal axis 404 and made of one or more materials to enhance and/or target electrical, thermal, and/or mechanical properties. The choke 400 includes a first end 406 and a second end 408 spaced from the first end 406 with respect to a longitudinal axis 404. The one or more sections 402 can include a first end section 410, a second end section 412 spaced from the first end section 410, and one or more inner sections 414 arranged between the first end section 410 and the second end section 412. Each of the one or more sections 402 includes one or more constituents. For instance, one of the one or more sections 402 can include a majority constituent 416 and one or more minority constituents 418. Additionally or alternatively, at least one or all of the one or more sections 402 can include one or more equal constituents. In general, it can be desirable to vary and/or select the majority and minority constituents 416, 418 to enhance and/or target electrical, thermal, and/or mechanical properties of the choke 400. In the present illustrative example, each of the one or more sections 402 includes a base 420 and one or more inserts 422 disposed in portion of the base 420 and spaced about the longitudinal axis 404. According to one aspect, the base 420 can be made of the majority constituent 416 and the one or more inserts 422 are made of the one or more minority constituents 418. According to another aspect, the base 420 can be made of one type of nanocrystalline material and the one or more inserts 422 can be made of one or more different types of nanocrystalline material.

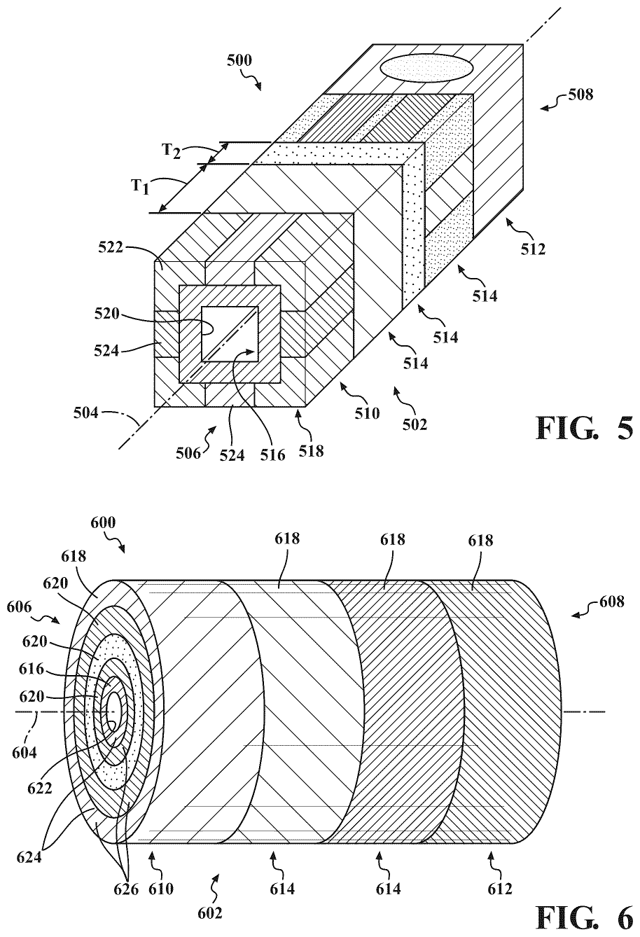

FIG. 5 illustrates another illustrative configuration of a choke 500. This configuration is similar in many respects to the configuration of FIGS. 1 and 2A-2C, FIG. 3, and FIG. 4. Accordingly, the descriptions of the configurations are hereby incorporated into one another, and description of subject matter common to the configurations generally may not be repeated.

With reference to FIG. 5, the choke 500 is provided and includes one or more sections 502 arranged adjacent to one another with respect to a longitudinal axis 504 and made of one or more materials to enhance and/or target electrical, thermal, and/or mechanical properties. The choke 500 includes a first end 506 and a second end 508 spaced from the first end 506 with respect to a longitudinal axis 504. The one or more sections 502 can include a first end section 510, a second end section 512 spaced from the first end section 510, and one or more inner sections 514 arranged between the first end section 510 and the second end section 512. In the present illustrative configuration, the first end section 510 includes a first or inner layer 516 and a second or outer layer 518 arranged radially with respect to the inner layer 516. According to one aspect, the inner layer 516 can define an opening 520 that extends between the first end 506 and the second end 508. Additionally, the inner layer 516 can be made of a first material, such as a nanocystalline material. The outer layer 518 can include a base portion 522 and one or more inserts 524 that are disposed in the base 522. According to one aspect, the one or more inserts 524 can be spaced from one another about the longitudinal axis 504. According to another aspect, the base 522 and the one or more inserts 524 can be made of one or more materials that are different than the first material. For example, the base 522 and the one or more inserts 524 can be made of one or more different types of nanocrystalline material or another material that is different than that of the inner layer 516.

With continued reference to FIG. 5, it can be desirable for the one or more inner sections 514 to be made of a single material to enhance and/or target electrical, thermal, and/or mechanical properties of the choke 500. According to one aspect, the inner sections 514 can include thicknesses T1, T2 that can be the same or different.

FIG. 6 illustrates another illustrative configuration of a choke 600. This configuration is similar in many respects to the configuration of FIGS. 1 and 2A-2C, FIG. 3, FIG. 4, and FIG. 5. Accordingly, the descriptions of the configurations are hereby incorporated into one another, and description of subject matter common to the configurations generally may not be repeated.

With reference to FIG. 6, the choke 600 is provided and includes one or more sections 602 arranged adjacent to one another with respect to a longitudinal axis 604 and made of one or more materials to enhance and/or target electrical, thermal, and/or mechanical properties. The choke 600 includes a first end 606 and a second end 608 spaced from the first end 606 with respect to the longitudinal axis 604. The one or more sections 602 can include a first end section 610, a second end section 612 spaced from the first end section 610, and one or more inner sections 614 arranged between the first end section 610 and the second end section 612. The one or more sections 602 can include a first or innermost layer 616 and a second or outermost layer 618 arranged radially with respect to the innermost layer 616. In the present illustrative embodiment, the first end section 610 also includes one or more intermediary layers 620 arranged radially between the innermost layer 616 and the outermost layer 618. The innermost layer 616 can define an opening 622 that extends between the first end 606 and the second end 608. According to one aspect, the innermost layer 616 can be made of a first material, the outermost layer 618 can be made of a second material, and the intermediary layers 620 can be made of one or more materials that are different than the first material and the second material. The combination of materials may vary to enhance and/or target electrical, thermal, and/or mechanical properties of the choke 600.

With continued reference to FIG. 6, the choke 600 can include a base 624 that can include the innermost layer 616 and the outermost layer 618 that is spaced radially from the innermost layer 616. Additionally, the choke 600 can include one or more inserts 626 that include the one or more intermediary layers that are arranged radially between the innermost layer 616 and the outermost layer 618.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A multi-material choke, comprising:
one or more sections arranged with respect to a longitudinal axis and extending between a first end and a second end, the one or more sections each defining at least one opening that extends between the first end and the second end, and the one or more sections including one or more materials arranged with respect to the longitudinal axis.

2. The multi-material choke of claim 1, wherein the at least one opening of each of the one or more sections are coaxial along the longitudinal axis.

3. The multi-material choke of claim 1, wherein at least one of the one or more sections includes a base and one or more inserts disposed in the base.

4. The multi-material choke of claim 3, wherein the one or more inserts are spaced about the longitudinal axis.

5. The multi-material choke of claim 4, wherein the base and the one or more inserts define the at least one opening that extends between the first end and the second end.

6. The multi-material choke of claim 5, wherein base is made of a first material and the one or more inserts are made of one or more materials that are different than the first material.

7. The multi-material choke of claim 3, further including one or more layers arranged radially inwardly with respect to the base and the one or more inserts.

8. The multi-material choke of claim 7, wherein the base, the one or more layers, and the one or more inserts of at least one of the one or more sections are made of different materials.

9. The multi-material choke of claim 1, wherein the one or more sections include a majority constituent and one or more minority constituents.

10. The multi-material choke of claim 9, wherein at least one of the majority constituent or the one or more minority constituents are made of a nanocrystalline material.

11. A multi-material choke for a vehicle, comprising:
one or more sections arranged adjacent to each other with respect to a longitudinal axis, the one or more sections each comprising:
a base;
one or more inserts disposed in the base; and
at least one opening defined by the base and the one or more inserts.

12. The multi-material choke of claim 11, wherein the base is made of a first material and the one or more inserts are made of one or more materials that are different than the first material.

13. The multi-material choke of claim 11, wherein the base includes a nanocystalline material and the one or more inserts include a nanocystalline material.

14. The multi-material choke of claim 11, wherein the base includes an inner layer and an outer layer that is spaced radially from the inner layer, and the one or more inserts are intermediary layers that are arranged radially between the inner layer and the outer layer.

15. The multi-material choke of claim 11, wherein the one or more inserts are arranged about a perimeter of the base and are spaced about the longitudinal axis.

16. The multi-material choke of claim 11, wherein the base includes a majority constituent and the one or more inserts includes one or more minority constituents.

17. A vehicle, comprising:
a vehicle body;
a propulsion system coupled to the vehicle body, comprising:
an inverter having an input and an output,
a battery communicatively coupled to the input of the inverter, and
a motor communicatively coupled to the output of the inverter; and
a multi-material choke arranged with respect to the propulsion system, comprising:
one or more sections arranged with respect to a longitudinal axis and extending between a first end and a second end, the one or more sections each defining at least one opening that extends between the first end and the second end, the one or more sections including a majority constituent and one or more minority constituents, the majority constituent being selected to target one of a mechanical, electrical, or thermal property and the one or more minority constituents being selected to target the other of a mechanical, electrical, or thermal property.

18. The vehicle of claim 17, wherein the multi-material choke is arranged between the battery and the input of the inverter.

19. The vehicle of claim 17, wherein the multi-material choke is arranged between the output of the inverter and the motor.

20. The vehicle of claim 17, wherein the multi-material choke is arranged within the motor.
